(19) United States
(12) Patent Application Publication
(10) Pub. No.: US 2008/0110321 A1
(43) Pub. Date: May 15, 2008

(54) Cajon incorporating a snare carpet

(75) Inventor: Reinhard Wening, Dietenhofen (DE)

Correspondence Address: BROWDY AND NEIMARK, P.L.L.C.;624 NINTH STREET, NW, SUITE 300, WASHINGTON, DC, 20001-5303, US

(73) Assignee: Roland Meinl Musikinstrumente GmbH & Co. KG, Neustadt/Aisch (DE)

(21) Appl. No.: 11/703,707

(22) Filed: Feb. 8, 2007

(30) Foreign Application Priority Data
Nov. 11, 2006 (DE) 10 2006 053 240.6

(51) Int. Cl. G10D 13/02

(52) U.S. Cl. 84/421

(57) ABSTRACT

In a cajon incorporating a snare carpet that rests against the reverse of a front plate, provision is made that the snare carpet is supported pivotable and actuatable by means of a pedal.

### BACKGROUND OF THE INVENTION

### Field of the Invention

The invention relates to a cajon incorporating a snare carpet that rests against the reverse of a front plate. The cajon is played with the player sitting on the top surface of the cajon and striking the outside of the front plate, which is thereby set into vibration. A snare carpet that rests against the inside of the front plate is also set into vibration by the vibrations of the front plate and produces a characteristic snare sound.

### SUMMARY OF THE INVENTION

With this as the starting point, the invention has as its object to further improve such a cajon in such a way that the sound of the musical instrument can be adjusted by the player during playing.

This object is met in such a way that the snare carpet is disposed pivotable, provision being made in particular for the pivot movement of the snare carpet to be actuatable by means of a pedal.

Correspondingly, the player is able, without interruption or impairment of the playing, by actuation of the pedal, to change the tone color of the instrument, i.e., to activate or deactivate the influence of the sound carpet.

To this end, provision may furthermore be made for the snare carpet to be pivotable between a position resting against the inside of the front plate and a pivoted-back position, wherein in the pivoted-back position it rests against a damper strip, which extends parallel to the front plate at a distance from the same substantially vertically. This accomplishes that not only is the snare carpet not excited by the front plate, but vibrations of the housing are damped in general.

The pedal is preferably supported pivotable in a side wall of the housing.

To provide for the transfer of the pivot movement of the foot pedal into a pivot movement of the snare carpet, various mechanisms are possible. One advantageous transfer mechanism provides that the pivot movement of the pedal is transferred via a pivot pin that is supported in a bearing, a lever projection fastened thereto, and via a pivot hinge onto an actuation rod, and from there via a pivot hinge onto an additional lever projection of a pivot arm, which, in turn, supports the snare carpet.

To attain a defined, faultless guiding, the distal end of the lever projection may be provided with a pin, which engages into a guide groove in the side wall.

The guide groove may be formed in a metal plate that is mounted to the side wall.

The invention will be explained in more detail below based on a preferred example embodiment in conjunction with the drawing:

### BRIEF DESCRIPTION OF THE DRAWING

FIG. 1 shows a perspective view of the cajon from the rear without back plate, and

FIG. 2 shows a side view to illustrate the actuation mechanism.

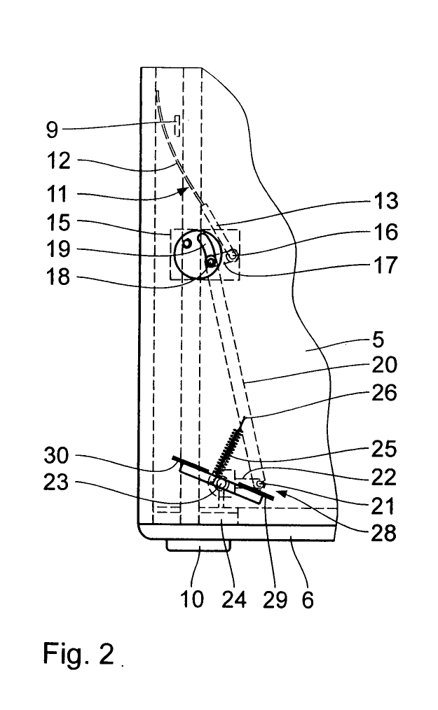

### DESCRIPTION OF THE PREFERRED EMBODIMENT

A cajon 1 shown in the drawing comprises a block-shaped wooden housing 2 having a cover plate 3, two side plates 4, 5, a bottom plate 6, and a front plate 7 on which it is played, as well as a back plate not shown in the drawing that has a sound opening. Extending in the region behind the front plate 7 is a vertical brace 8. Extending crosswise to the same is a horizontal damper strip 9. Located underneath the base plate 6 are feet 10.

A so-called snare carpet 11 consisting of a plurality of wire elements 12 extending parallel to one another, and a support plate 13, which is disposed on a pivot arm 14 that is pivot-mounted on a metal plate 15 on the inside of the side wall 5 at 16. Provided at the inner end, i.e., in the region of the pivot bearing 16, extending away from the pivot arm 14 is a lever projection 17, at the distal end of which a bolt 18 is provided, which engages into a circular-segment shaped link guide 19 in the metal plate 15. The pin 18 is hinged to an actuation arm 20 that extends in the direction toward the bottom plate 6 and which, in turn, is connected via a hinge 21 to a lever 22, said lever 22, in turn, being rigidly connected to a pivot pin 23 that is disposed in a bearing 24, which is supported on the bottom plate 6.

A helical spring 25 extends between a fastening region 26 on the actuation arm 20 and a fastening region 26 on the bearing 24.

The pivot pin 23 that is supported in the bearing 24 extends through an opening 27 of the side wall 5 to the outside, where a pedal 28 is affixed that has two treads 29, 30.

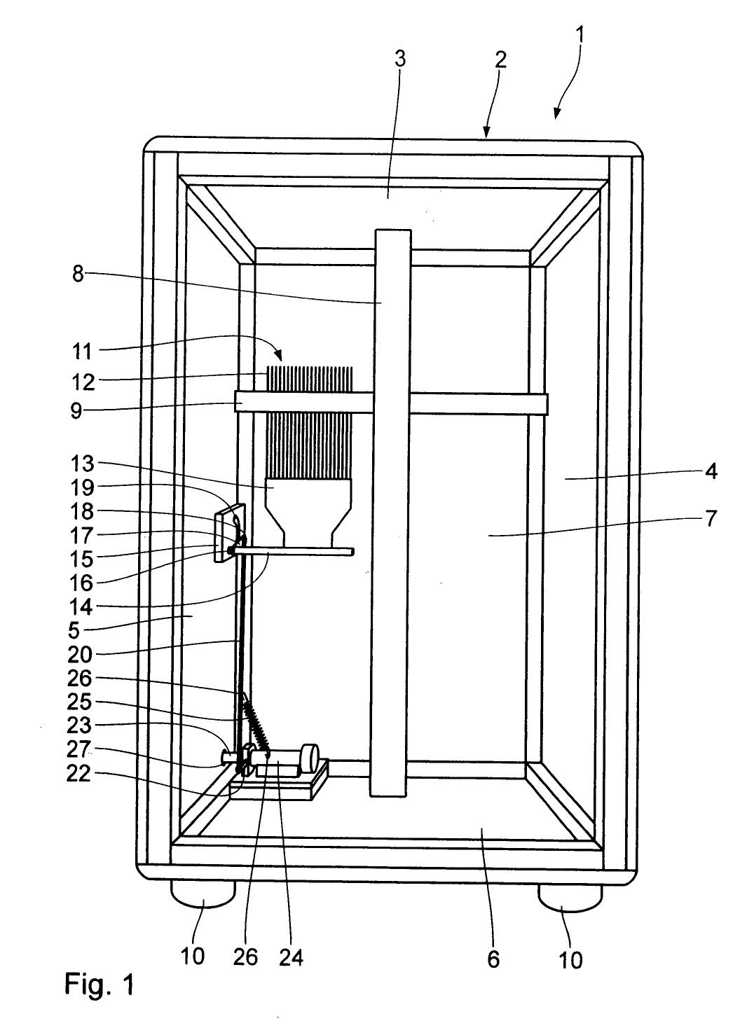

From the above-described mechanism it becomes apparent that by actuation of the frontal tread 30 of the pedal 28 and downward pivoting of the same, the snare carpet 11 is pivoted away from the front plate 7, namely away from the striking surface toward the rear, i.e., in FIG. 1 toward the observer, until it comes to rest against the damper strip 9. The sound effect of the snare carpet 11 is thereby deactivated. If, conversely, the tread 29 is depressed downward, this has the effect that the snare carpet 11 comes to rest against the inside of the front plate 7 and the snare effect is activated.

What is claimed is:

1. A cajon incorporating a snare carpet that rests against the reverse of a front plate, wherein the snare carpet (11) is mounted pivotable.

2. A cajon according to claim 1, wherein the pivot movement of the snare carpet (11) is actuatable by means of a pedal (28).

3. A cajon according to claim 1, wherein the snare carpet (11) is pivotable between a position resting against the inside of the front plate (7) and a pivoted-back position, wherein in the pivoted-back position it rests against a damper strip (9), which extends parallel to the front plate (7) at a distance from the same substantially vertically.

4. A cajon according to claim 1, wherein the pedal (28) is supported pivotable in a side wall (5) of the housing (2).

5. A cajon according to claim 1, wherein the pivot movement of the pedal (28) is transferred via a pivot pin (23) that is supported in a bearing (24), a lever projection (22) fastened thereto, and via a pivot hinge (21) onto an actuation rod (20), and from there via a pivot hinge (18) to an additional lever projection (17) of a pivot arm (14), which supports the snare carpet (11).

6. A cajon according to claim 5, wherein the distal end of the lever projection (17) is provided with a pin (18), which engages into a guide groove (19) in the side wall (5).

7. A cajon according to claim 6, wherein the guide groove (19) is formed in a metal plate (15) that is mounted to the side wall (5).
